(19) United States
(12) Patent Application Publication
(10) Pub. No.: US 2005/0045536 A1
(43) Pub. Date: Mar. 3, 2005

(54) Treatment liquid supply system

(75) Inventors: Yuki Hamada, Tokyo (JP); Hidetoshi Matoh, Kanagawa (JP)

Correspondence Address: LAUBSCHER SEVERSON, 1160 SPA RD, SUITE 2B, ANNAPOLIS, MD, 21403, US

(73) Assignee: Fujimori Technical Laboratory Inc., Tokyo (JP)

(21) Appl. No.: 10/653,869

(22) Filed: Sep. 3, 2003

(51) Int. Cl. B01D 17/12

(52) U.S. Cl. 210/97; 210/257.1; 222/52; 210/406

(57) ABSTRACT

In a treatment liquid supply system that supplies treatment liquid used for coating industrial objects for film formation including a semiconductor substrate, a display substrate, a glass and the like, a nozzle is connected to a treatment liquid tank and the nozzle vacuum-sucks and injects the treatment liquid from the treatment liquid tank due to a negative pressure occurring in the nozzle, wherein supply control of a small flow amount of the treatment liquid to the nozzle can be performed due to a difference pressure between pressure in the treatment liquid tank and the negative pressure occurring in the nozzle.

### BACKGROUND OF THE INVENTION

1. Field of the Invention

The present invention relates to a treatment liquid supply system that supplies treatment liquid used for coating industrial objects for film formation including a semiconductor substrate, a display substrate, a glass and the like, and in particular, to a treatment liquid supply system that performs supply control of a small flow amount of the treatment liquid by using a nozzle that vacuum-sucks and injects the treatment liquid from a treatment liquid tank.

2. Description of the Related Art

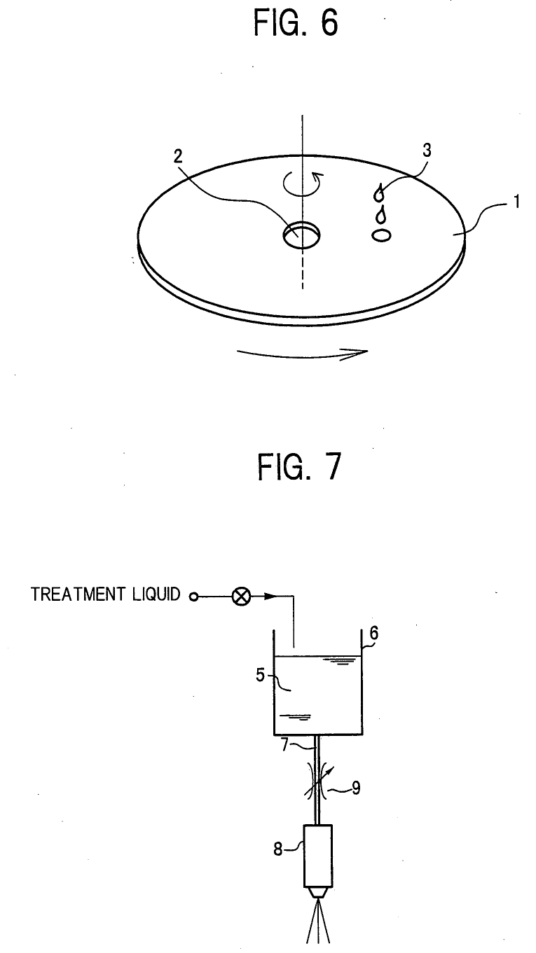

There is an earlier treatment liquid supply system where, when a film is coated on a semiconductor substrate and a display substrate in a manufacturing process of a semiconductor apparatus, a liquid crystal display apparatus and so on, as shown in FIG. 6, a wafer 1 rotates at a high speed with the wafer 1 being supported horizontally and treatment liquid 3 is dripped at a location near a central bore 2 of the wafer 1 from above the wafer 1.

Centrifugal force effecting on the treatment liquid 3 dripped on the wafer 1 that rotates at a high speed makes the treatment liquid to radially spread out on the surface of the wafer 1 to form a film as coated on the entire surface of the wafer 1.

As another example, in case where treatment liquid is coated on a semiconductor substrate and a display substrate by spray coating, as shown in FIG. 7, a treatment liquid supply system that comprises a treatment liquid tank 6 containing treatment liquid 5 therein, a treatment liquid supply pipe 7 connected to the treatment liquid tank 6, and a nozzle 8 connected to the treatment liquid supply pipe 7 wherein the nozzle 8 discharges the treatment liquid 5 supplied from the treatment liquid tank 6. A flow amount adjustment valve 9 such as a needle valve is disposed in the middle of the treatment liquid supply pipe 7 to control supply amount of the treatment liquid to the nozzle 8 whereby the treatment liquid 5 is discharged for coating from the nozzle 8 by controlling a flow amount of the treatment liquid supply through the flow amount adjustment valve 9 with the treatment liquid 5 inside the treatment liquid tank 6 being pressurized or with the treatment liquid 5 being supplied by a pump (not shown).

In the earlier apparatus as shown in FIG. 6, however, when an amount of the treatment liquid 3 dripped on the wafer 1 becomes so small, the treatment liquid 3 does not disperse. Therefore, the treatment liquid 3 of more than 10 ml/min is necessary to drip wherein the treatment liquid 3 disperses toward the outer direction by centrifugal force of the high-speed-rotating wafer 1 and part of the treatment liquid 3 is coated on the surface of the wafer 1 and the rest thereof drops outside of the wafer 1.

As described above, an efficiency of the treatment liquid coating deteriorates and the treatment liquid supply apparatus is not economical due to a large amount of the treatment liquid 3 being dripped, as well as being wasted discarded outside of the wafer 1. Moreover, An environment around the apparatus is possibly polluted by the treatment liquid 3 wasted outside of the wafer 1.

In the earlier apparatus as shown in FIG. 7, flow control of the treatment liquid 5 supplied to the nozzle 8 is performed by the flow amount adjustment valve 9 such as a needle valve disposed in the middle of the treatment liquid supply pipe 7 and as a result, such flow amount adjustment valve 9 does not enable flow control of the treatment liquid 5 at an amount of 1 ml/min or less than it. Therefore, it is difficult to evenly coat a film on an object by supplying the treatment liquid 5 of less than 1 ml/min. Further, if foreign matter such as dusts and carbons is mixed with the treatment liquid 5 inside the treatment liquid tank 6, it causes plugging in the passage to the nozzle 8, thereby to block supplying of the treatment liquid 5 to the nozzle 8 and therefore, processing of a treatment liquid coating does not proceed smoothly.

### SUMMARY OF THE INVENTION

The present invention, in view of the foregoing problems, has an object of providing a treatment liquid supply system that performs supply control of a small flow amount of treatment liquid by using a nozzle that vacuum-sucks and injects the treatment liquid from a treatment liquid tank.

In order to achieve the above object, a treatment liquid supply system according to the invention, comprises a treatment liquid tank containing treatment liquid therein with the treatment liquid tank being tightly closed, a nozzle connected to the treatment liquid tank through a treatment liquid supply pipe wherein the nozzle vacuum-sucks and injects the treatment liquid in the treatment liquid tank due to vacuum occurring in the nozzle caused by supplying pressurized air from outside of the nozzle thereto, an air suction device connected to an upper side of the treatment liquid tank wherein the air suction device generates vacuum therein by sucking in air in an inner space thereof, and a positive pressure supply device that supplies a positive pressure gas at a desired pressure to a vacuum space formed inside the treatment liquid tank, wherein flow supply of the treatment liquid to the nozzle is controlled by adjusting pressure of the positive-pressure gas supplied to the treatment liquid tank by the positive pressure supply device.

According to the above construction, the flow supply of the treatment liquid to the nozzle is controlled in a way that the treatment liquid is stored in the closed treatment liquid tank, the nozzle is connected to the treatment liquid tank through a treatment liquid supply pipe wherein the nozzle vacuum-sucks and injects the treatment liquid in the treatment liquid tank due to vacuum occurring in the nozzle caused by supplying pressurized air from outside of the nozzle thereto, the air suction device is connected to an upper side of the treatment liquid tank wherein the air suction device generates vacuum therein by sucking in air in an inner space thereof, and the positive pressure supply device supplies a positive pressure gas at a desired pressure to a vacuum space formed inside the treatment liquid tank, wherein flow supply of the treatment liquid to the nozzle is controlled by adjusting pressure of the positive pressure gas supplied to the treatment liquid tank by the positive pressure supply device.

The pressure control device that adjusts pressure of a positive pressure gas supplied to the treatment liquid tank is provided between the positive pressure supply device and the treatment liquid tank, thereby to easily adjust the pressure of the positive pressure gas supplied to treatment liquid tank.

Moreover, the pressure control device may be a mass flow controller that adjusts a flow amount of the positive pressure gas by measuring flow mass thereof, thereby to definitely adjust the flow amount of the positive pressure gas supplied to the treatment liquid tank in proportion to the flow mass thereof without influence of pressure or temperature change thereof and easily adjust the pressure of the positive pressure gas supplied to the treatment liquid tank.

Further, the positive pressure supply device supplies an atmospheric gas or an inert gas. Particularly when the inert gas is supplied, the pressure is stably kept without affecting the treatment liquid in the treatment liquid tank.

### BRIEF DESCRIPTION OF THE DRWAINGS

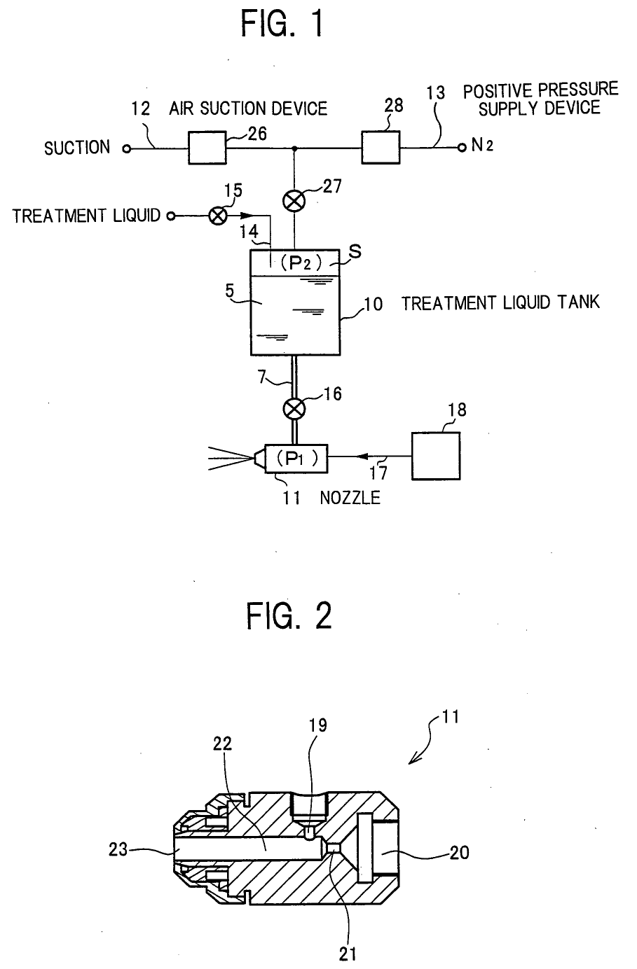

FIG. 1 is a system schematic view showing an embodiment of a treatment liquid supply system according to the invention.

FIG. 2 is a cross section view showing an embodiment of a nozzle used in the treatment liquid supply system.

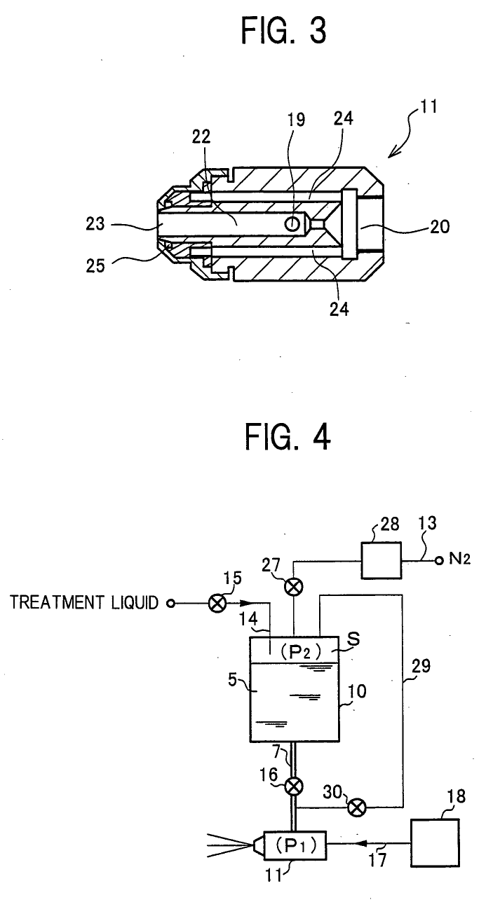

FIG. 3 is a cross section view showing the embodiment of the nozzle in a cross section perpendicular to the cross section in FIG. 2.

FIG. 4 is a system schematic view showing another embodiment of a treatment liquid supply system according to the invention.

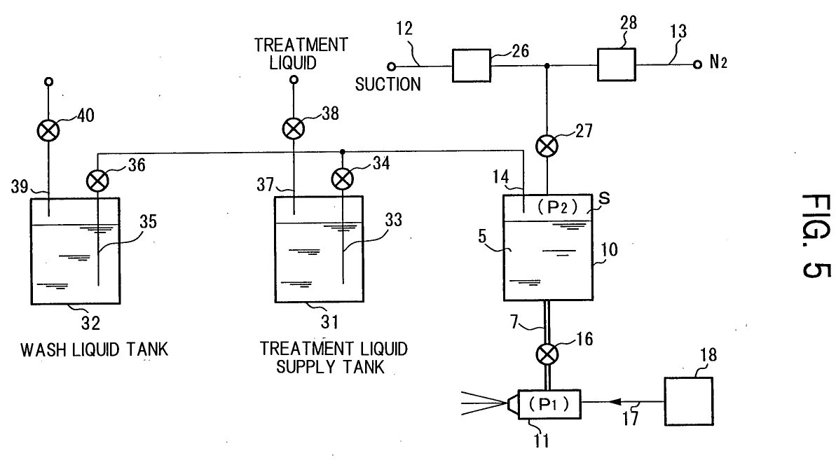

FIG. 5 is an entire view of a system to which the treatment liquid supply system of the embodiment shown in FIG. 1 is applied.

FIG. 6 is an explanation view showing a state where a film is coated on a semiconductor substrate and a display substrate in an earlier apparatus.

FIG. 7 is a system schematic view showing a treatment liquid supply system that coats treatment liquid on a substrate by splay coating in an earlier apparatus.

### DETAILED DESCRIPTION OF THE PREFERRED EMBODIMENTS

FIG. 1 is a system schematic view showing an embodiment of a treatment liquid supply system according to the invention. The treatment liquid supply system supplies treatment liquid where the treatment liquid for various treatments is coated on industrial objects for film formation including a semiconductor substrate, a display substrate, a glass and the like, and comprises a treatment liquid tank 10, a nozzle 11, an air suction device 12, and a positive pressure supply device 13.

The treatment liquid tank 10 stores various types of treatment liquid 5 coated on the industrial objects for film formation and the treatment liquid tank 10 is formed as a vessel of a certain size and tightly closed by covering an upper side thereof by a lid, thereby to be able to form a vacuum space inside the treatment liquid tank 10. A pipe line 14 is connected to the upper side of the treatment liquid tank 10 to supply the treatment liquid 5 thereto. A valve 15 is disposed in the middle of the pipe line 14 to open and close the pipe line 14.

A treatment liquid supply pipe 7 is connected to the bottom of the treatment liquid tank 10 and a nozzle 11 is connected to a tip of the treatment liquid supply pipe 7. A valve 16 is disposed in the treatment liquid supply pipe 7 to open and close a supply passage to the nozzle 11. The nozzle 11 vacuum-sucks the treatment liquid 5 supplied through the treatment liquid supply pipe 7 from the treatment liquid tank 10 caused by supplying pressurized air from outside thereof and injects it. The tip of the treatment liquid supply pipe 7 is connected to a side portion of the nozzle 11 and a highly-pressurized-air supply pipe 17 is connected to an axial portion of the nozzle 11. A compressor 18 is disposed in an end of the highly-pressurized-air supply pipe 17.

Each of FIG. 2 and FIG. 3 is a cross section showing an embodiment of a detailed structure of the nozzle 11. FIG. 2 is a vertical cross section including a portion to which the treatment liquid supply pipe 7 is connected and FIG. 3 is a vertical cross section perpendicular to the cross section in FIG. 2.

In FIG. 2, a treatment liquid inlet 19 is formed at the side portion of the nozzle 11 and the tip of the treatment liquid supply pipe 7 is connected to the inlet 19. A highly-pressurized-air inlet 20 is formed at a rear end of the axial portion of the nozzle 11 and the tip of the highly-pressurized-air supply pipe 17 is connected to the inlet 20.

In this state, when a highly-pressurized air supplied through the highly-pressurized-air supply pipe 17 by operating the compressor 18 shown in FIG. 1 flows into the axial portion of the nozzle 11 and enters into an inner mixture chamber 22 via a primary-air spout outlet 21 of a small diameter, a vacuum occurs at a location of the inlet 19 to which the treatment liquid supply pipe 7 shown in FIG. 1 is connected, due to an effect of a venturi tube, thereby to sucking in the treatment liquid 5 from the treatment liquid supply pipe 7 to the inner mixture chamber 22. The high-speed air spouted from the primary-air spout outlet 21 strikes the treatment liquid 5 sucked from the inlet 19 to pieces, as well as is mixed with the treatment liquid 5 in the wider-inner mixture chamber 22, thereby to slow down, and is injected from a spout outlet 23 at a nozzle tip.

On the other hand, as shown in FIG. 3, the highly-pressurized air flown into the nozzle 11 from the highly-pressurized-air inlet 20 goes to a secondary-air spout groove 25 formed in a spiral shape at the tip of the nozzle 11 through a secondary-air passage 24 formed at an outer side from the axial portion in the nozzle 11 and is injected in a high-speed swirl from the groove 25. Then, the highly-pressurized air forms atomization of the treatment liquid 5 by a secondary mixing with the treatment liquid 5 in the inner mixture chamber 22 and injects forward the atomized treatment liquid 5 from the spout outlet 23. In FIG. 2 and FIG. 3, the nozzle 11 injects in a swirl, but not limited thereto, may be a normal nozzle that does not form a swirl.

The air suction device 12 is connected to the upper side of the treatment liquid tank 10 as shown in FIG. 1 and builds vacuum therein by sucking in air of an inner space S in the treatment liquid tank 10 and includes a pipe line connected to a vacuum pump at a base end thereof. A pressure controller 26 is disposed between the air suction device 12 and the treatment liquid tank 10 to control vacuum occurring due to sucking by the vacuum pump, and an opening and closing valve 27 is disposed prior to connection of the pressure controller 26 to the treatment liquid tank 10.

A positive pressure supply device 13 is connected to the upper side of the treatment liquid tank 10 and supplies a positive pressure gas at a desired pressure to the vacuum space S formed inside the treatment liquid tank 10 and includes a pipe line connected to a nitrogen gas bomb at a base end thereof that supplies an inert gas of 1-2 atm, for example, nitrogen gas (N 2). A pressure controller 28 is disposed between the positive pressure supply device 13 and the treatment liquid tank 10 to control pressure of a positive pressure gas supplied to the treatment liquid tank 10, namely to control pressure of the nitrogen gas supplied from the nitrogen gas bomb. The pipe line of the air suction device 12 and the pipe line of the positive pressure supply device 13 is connected in the way to the treatment liquid tank 10 to form a common pipe line thereto in which the opening and closing valve 27 is disposed.

The positive pressure supply device 13 supplies a positive pressure gas to the treatment liquid tank 10 via the controller 28 that adjusts the pressure of the positive pressure gas, thereby to easily control the pressure of the positive pressure gas to the treatment liquid tank 10. Accordingly, supply of the treatment liquid to the nozzle 11 can be controlled by a preciously slight amount by adjusting the pressure inside the treatment liquid tank 10.

An operation of the treatment liquid supply system as described above will be explained next. In FIG. 1, a predetermined amount of the treatment liquid 5 is supplied to the treatment liquid tank 10 by opening the valve 15 in the pipe line 14. Thereafter, the treatment liquid tank 10 becomes tightly closed by closing the valve 15, as well as closing the valve 27 in the common line to the treatment liquid tank 10 between the air suction device 12 and the positive pressure supply device 13.

On this occasion, the valve 16 in the treatment liquid pipe 7 connected to the bottom of the treatment liquid tank 10 becomes closed and the valve 27 in the common pipe between the air suction device 12 and the positive pressure supply device 13 becomes opened and the vacuum pump connected to the air suction device 12 becomes driven to suck in air in the inner space S of the treatment liquid tank 10, thereby to generate a negative pressure (for example, from 0.1 to 0.4 atm) therein.

Next, the valve 16 becomes opened, as well as a highly-pressurized air is supplied to the nozzle 11 via the highly-pressurized-air supply pipe 17 from the compressor 18 shown in FIG. 1. Then, as described above, the negative pressure (for example, from 0.1 to 0.4 atm) occurs at a location of the treatment liquid inlet 19 in the nozzle 11, which causes suction of the treatment liquid 5 from the treatment liquid supply pipe 7. On this occasion, since the pressure in the inner space S of the treatment liquid tank 10 is negative, the negative pressure P₁ occurring in the nozzle 11 and the negative pressure P₂ in the inner space S of the treatment liquid tank 10 are regulated to be equal. A pressure gage to measure pressure P₁ may be mounted in the treatment liquid supply pipe 7 downstream of the valve 16 and a pressure gage to measure pressure P₂ in the inner space S of the treatment liquid tank 10 may be mounted.

When P₁=P₂, the treatment liquid 5 dose not flow and the treatment liquid 5 becomes stable to stay therein. This state is determined to be an initial state of the treatment liquid supply and a process of the treatment liquid supply starts from this state. Then, since flow of the treatment liquid 5 stops in the vicinity of the treatment liquid inlet 19 in the nozzle 11, a path to the nozzle 11 does not dry up. Accordingly, the treatment liquid 5 can be injected from the nozzle 11 quickly thereafter.

Next, an spout outlet 23 of the nozzle 11 is set to be directed to an object coated by the treatment liquid 5 and the compressor 18 supplies the highly-pressurized air to the nozzle 11 through the highly-pressurized-air supply pipe 17 in the same as the above. However, since P₁=P₂ on this occasion, the treatment liquid 5 is not injected from the nozzle 11. Therefore, a pressure of the positive pressure gas supplied to the treatment liquid tank 10 is regulated by properly adjusting the pressure controller 28 disposed in the positive pressure supply device 13 shown in FIG. 1. As a result, the pressure P₂ increases with change of the pressure in the treatment liquid tank 10, causing a pressure difference between P₁ and P₂. The treatment liquid 5 is supplied to the nozzle 11 from the treatment liquid tank 10 due to the pressure difference. Accordingly, the treatment liquid 5 is injected from the nozzle 11.

The pressure difference between P₁ and P₂ is minutely adjusted as a result of a minute pressure adjustment of the pressure controller 28, thereby to minutely control supply flow of the treatment liquid 5 to the nozzle 11. For example, supply amount of the treatment liquid 5 can be controlled in the range of approximately 1 ml/min or less than it (for example, approximately from 0.1-0.9 ml/min) which is impossible in an earlier apparatus. Accordingly, the supply of the treatment liquid 5 can be minutely controlled due to the difference between the pressure in the treatment liquid tank 10 and the negative pressure occurring in the nozzle 11, thereby to evenly coat the treatment liquid 5 on the object.

Moreover, an efficiency, as well as economy of treatment liquid coating improves by reducing an amount of the treatment liquid 5 used. Further, the negative pressure in the treatment liquid tank 10 performs deaeration of the treatment liquid 5 received therein and prevents a vapor lock in the treatment liquid supply pipe 7 to the nozzle 11. Also even if the viscosity of the treatment liquid 5 is high, the treatment liquid 5 can be supplied to the nozzle 11 due to a difference (pressure difference between P₁ and P₂) between the negative pressure in the nozzle 11 and the pressure in the treatment liquid tank 10. Since a flow amount adjustment valve such as an earlier needle valve is not disposed in the treatment liquid supply pipe 7 to the nozzle 11, the treatment liquid 5 can be smoothly supplied to the nozzle 11 with no foreign matter being stuck therein.

As shown in FIG. 1, the pressure controller 28 is disposed as a pressure control device for the positive pressure supply device 13, but the invention is not limited thereto, and a mass flow controller to measure and control a mass of the flow amount of the positive pressure gas may be used. In this case the flow amount of the positive pressure gas supplied to the treatment liquid tank 10 is stably adjusted in proportion to a mass of the flow amount thereof without influence of change of pressure and temperature, and the pressure of the positive pressure gas supplied to the treatment liquid tank 10 is easily adjusted. Accordingly, the pressure in the treatment liquid tank 10 is easily and stably adjusted and the supply of the treatment liquid 5 to the nozzle 11 can be minutely controlled. Also an air may be supplied instead of supplying nitrogen gas to the positive pressure supply device 13.

FIG. 4 is a system schematic view showing a different embodiment according to the invention. In the embodiment, the air suction device 12 and the pressure controller 26 shown in FIG. 1 are omitted and the treatment liquid supply pipe 7 is branched immediately prior to the nozzle 11 to form a pipe line 29 that is connected to the upper side of the treatment liquid tank 10 and is used as an air suction device. A valve 30 to open and close the pipe line 29 is disposed therein.

In order to suck in air in the inner space S in the treatment liquid tank 10 and generate a negative pressure therein, the valve 16 in the treatment liquid supply pipe 7 becomes closed and the valve 30 in the branched pipe line 29 becomes opened wherein a highly-pressurized air is supplied to the nozzle 11 via the highly-pressurized-air supply pipe 17 from the compressor 18. Then, as explained in reference to FIG. 2, a negative pressure (for example, from 0.1 to 0.4 atm) occurs at a location of the treatment liquid inlet 19 in the nozzle 11 and this negative pressure becomes associated with the inner space S in the treatment liquid tank 10 via the pipe line 29 and as a result, sucks in the air in the inner space S. According to this air suction, the pressure in the space S in the treatment liquid tank 10 becomes a negative pressure P₂ (for example, from 0.1 to 0.4 atm). In this state the valve 30 in the pipe line 29 becomes closed.

In the treatment liquid supply system of the embodiment, the air suction device 12 and the pressure controller 26 shown in FIG. 1 are replaced by the air suction device as the branched pipe line 29 wherein after the pipe line 29 sucks in the air in the inner space S in the treatment liquid tank 10 and the pressure therein becomes a negative pressure P₂, the valve 16 in the treatment liquid supply pipe 7 becomes opened, and the rest of the construction operates the same way as in FIG. 1. In the embodiment, since pressure of the inner space S in the treatment liquid tank 10 is made to be a negative pressure P₂ without the air suction device 12 and the pressure controller 26 shown in FIG. 1, as well as the vacuum pump (not shown), the whole construction can be simplified.

FIG. 5 is a detailed embodiment of a treatment liquid supply system using the embodiment shown in FIG. 1. In the embodiment a treatment supply tank 31 and a wash liquid tank 32 are connected to the treatment liquid tank 10 to supply the treatment liquid and wash liquid to the treatment liquid tank 10. A treatment liquid suction pipe 33 is inserted into the treatment liquid supply tank 31 and connected to the pipe line 14 to supply the treatment liquid 5 to the treatment liquid tank 10 through a valve 34 for opening and closing connection between the pipe line 14 and the suction pipe 33. A wash liquid suction pipe 35 is inserted into the wash liquid tank 32 and connected to the pipe line 14 through a valve 36 for opening and closing connection therebetween. The treatment liquid suction pipe 33 and the wash liquid suction pipe 35 are connected to the treatment liquid tank 10 through the pipe line 14 as a common line.

A treatment liquid supplementary pipe 37 is connected to the upper side of the treatment liquid supply tank 31 and a valve 38 is disposed prior to a treatment liquid supplementary inlet of the treatment liquid supplementary pipe 37 for opening and closing it. A wash liquid supplementary pipe 39 is connected to the upper side of the wash liquid tank 32 and a valve 40 is disposed prior to a wash liquid supplementary inlet of the wash liquid supplementary pipe 39 for opening and closing it.

In order to supply the treatment liquid 5 to the treatment liquid tank 10 according to the above construction, firstly the valve 36 in the wash liquid suction pipe 35 is closed and also the valve 34 in the treatment liquid suction pipe 33 is opened and the valve 16 in the treatment liquid supply pipe 7 of the treatment liquid tank 10 is closed.

Secondly, the valve 27 for the air suction device 12 is opened and the negative pressure occurs caused by sucking in the air in the inner space S of the treatment liquid tank 10 due to driving the vacuum pump connected to the air suction device 12. Accordingly, the treatment liquid is sucked from the treatment liquid supply tank 31 due to the negative pressure in the inner space S and the treatment liquid 5 is supplied to the treatment liquid tank 10 through the pipe line 14. Thereafter, the valve 34 is closed to end supply of the treatment liquid wherein the pressure in the inner space S of the treatment liquid tank 10 is kept to be a negative pressure.

When the treatment liquid 5 is supplied as above, the valve 16 in the treatment liquid supply pipe 7 is opened, as well as the highly-pressurized air is supplied to the nozzle 11 through the highly-pressurized-air supply pipe 17 from the compressor 18, thereby to inject the treatment liquid 5 from the nozzle 11 in the same way as explained in reference to FIG. 1.

Next, when coating by a certain amount of the treatment liquid 5 is finished and thereafter, the treatment liquid tank 10 and the treatment liquid supply pipe 7 are washed, the treatment liquid 5 is discharged from the treatment liquid tank 10 and the wash liquid is supplied to the treatment liquid tank 10. The valve 34 in the treatment liquid suction pipe 33 is closed, as well as the valve 36 in the wash liquid suction pipe 35 is opened and the valve 16 in the treatment liquid supply pipe 7 of the treatment liquid tank 10 is closed. Then, the valve 27 for the air suction device 12 is opened and the negative pressure occurs caused by sucking in the air in the inner space S of the treatment liquid tank 10 due to driving the vacuum pump connected to the air suction device 12. Accordingly, the wash liquid is sucked from the wash liquid tank 32 due to the negative pressure in the inner space S and is supplied to the treatment liquid tank 10 through the pipe line 14. Thereafter, the valve 36 is closed to end supply of the wash liquid.

Further, the valve 16 in the treatment liquid supply pipe 7 is opened and the valve 27 for the air suction device 12 and the positive pressure supply device 13 is opened. As a result, the treatment liquid tank 10 and the treatment liquid supply pipe 7 are washed by flow of the wash liquid caused by supplying the positive pressure to the treatment liquid tank 10 from the positive pressure supply device 13 or caused by sucking in the air in the treatment liquid tank 10 by the air suction device 12. Then the supply of the positive pressure gas by the positive pressure supply device 13 and the suction by the air suction device 12 stop and the wash ends by discharging the wash liquid to the outside.

FIG. 5 shows the detailed embodiment of the treatment liquid supply system to which the embodiment in FIG. 1 is applied and another detailed embodiment can be made by applying the embodiment shown in FIG. 4 in the same way as in FIG. 5.

1. A treatment liquid supply system comprising:
a treatment liquid tank that contains treatment liquid therein with the treatment liquid tank being tightly closed;
a nozzle connected to the treatment liquid tank through a treatment liquid supply pipe wherein the nozzle vacuum-sucks and injects the treatment liquid in the treatment liquid tank due to vacuum occurring in the nozzle caused by supplying pressurized air from outside of the nozzle thereto;
an air suction device connected to an upper side of the treatment liquid tank wherein the air suction device generates vacuum therein by sucking in air in an inner space thereof; and
a positive pressure supply device that supplies a positive pressure gas at a desired pressure to a vacuum space as formed in the inner space of the treatment liquid tank wherein flow supply of the treatment liquid to the nozzle is controlled by adjusting pressure of the positive pressure gas supplied to the treatment liquid tank by the positive pressure supply device.

2. A treatment liquid supply system according to claim 1, further comprising:
a pressure control device disposed between the positive pressure supply device and the treatment liquid tank to adjust the pressure of the positive pressure gas supplied to the treatment liquid tank.

3. A treatment liquid supply system according to claim 2, wherein the pressure control device comprises:
a mass flow controller that adjusts a flow amount by measuring a mass of the flow amount of the positive pressure gas.

4. A treatment liquid supply system according to claim 1, wherein an atmosphere or an inert gas is supplied to the positive pressure supply device.

5. A treatment liquid supply system according to claim 2, wherein an atmosphere or an inert gas is supplied to the positive pressure supply device.

6. A treatment liquid supply system according to claim 3, wherein an atmosphere or an inert gas is supplied to the positive pressure supply device.
